(19) United States
(12) Patent Application Publication
(10) Pub. No.: US 2021/0158236 A1
(43) Pub. Date: May 27, 2021

(54) AI DRIVEN SUPPLIER SELECTION AND TAM ALLOCATION

(71) Applicant: EMC IP Holding Company LLC, Hopkinton, MA (US)

(72) Inventors: Sathish Kumar Bikumala, Round Rock, TX (US); Shibi Panikkar, Bangalore (IN); Deepak NagarajeGowda, Cary, NC (US)

(21) Appl. No.: 16/693,819

(22) Filed: Nov. 25, 2019

(51) Int. Cl. G06Q 10/06; G06N 3/08; G06N 20/10; G06K 9/62

(52) U.S. Cl. CPC G06Q 10/0635; G06K 9/6278; G06N 20/10; G06N 3/08

(57) ABSTRACT

A machine learning (ML) module that can continuously learn from the market data and historical orders to dynamically recommend an optimum supplier portfolio to the manufacturer for a specific product. Using artificial intelligence, this analytical tool automates the supplier selection process based on evaluation of each supplier against a number of business features. The limitations of a manual selection of suppliers are substantially alleviated when each supplier is rigorously and automatically evaluated against a well-designed set of business features. For each supplier, the ML module generates a set of feature-specific scores for the business features used in evaluating the supplier. All scores are then combined to generate a supplier-specific final score for each supplier. The ML module uses the supplier scores to dynamically allocate Total Available Material (TAM) percentages to a pre-defined number of top-ranked suppliers to assist the manufacturer in the selection of best suppliers for the desired product.

### TECHNICAL FIELD

This disclosure relates generally to selection of a product supplier and, more particularly, to an Artificial Intelligence (AI) based selection of suppliers in the marketplace based on dynamic generation of Total Available Material (TAM) percentages for the suppliers associated with a Material Requisition Plan (MRP) for a product to be procured by a manufacturer.

### BACKGROUND

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Modern information handling systems include many different types of consumer and commercial electronic devices such as, for example, personal computers (e.g., desktops or laptops), tablet computers, mobile devices (e.g., personal digital assistants (PDAs) or smart phones), corporate (or small business) server and data processing systems, and the like. These devices may vary in size, shape, performance, functionality, and price. In any event, almost all of these modern devices are equipped with relevant hardware and software to allow their users to access a number of different websites over the Internet and perform online transactions.

Different types of information handling systems include different types of hardware components and raw materials. The term “product” may be used herein to refer to a hardware component or raw material of an information handling system. A manufacturer of an information handling system may receive or procure relevant products from a single or multiple different third-party suppliers or vendors. In the industry, it may be risky to purchase from a single supplier, especially when multiple suppliers are available. Therefore, to mitigate financial and other marketplace risks, the manufacturer may purchase the same product from more than one supplier; each supplier fulfilling a certain percentage of the product order. In the product manufacturing/assembly environment, the supplier selection and percentage allocation may be carried out manually using the following three primary factors: (i) business relationship of the manufacturer with the supplier, (ii) price (per product) offered by the supplier, and (iii) capability of the supplier to supply the requested product in the ordered quantity.

### SUMMARY

This Summary provides a simplified form of concepts that are further described below in the Detailed Description. This Summary is not intended to identify key or essential features and should therefore not be used for determining or limiting the scope of the claimed subject matter.

In the context of selecting suppliers of a product that may be used as part of an information handling system, the present disclosure relates to using an AI-based machine learning (ML) module to automate the supplier selection process based on evaluation of each supplier against a number of business features such as, for example, how efficiently a supplier can supply the product; how flexible the supplier is as to quantity, quality, and delivery of the product; financial and innovation strength of the supplier; overall cost competitiveness of the supplier; an average time the supplier takes to deliver the product; and an overall product delivery risk associated with the supplier. For each supplier, the ML module may generate a set of feature-specific scores for the business features used in evaluating the supplier. All scores may be then combined to generate a supplier-specific final score for each supplier. Furthermore, in certain embodiments, the ML module may provide feature-specific predictions for each supplier based on the analysis of feature-specific scores for the supplier. The ML module may use the supplier scores to dynamically allocate Total Available Material (TAM) percentages to a pre-defined number of top-ranked suppliers to assist the manufacturer in the proper selection of suppliers for the desired product. In some embodiments, the ML module may be dynamically trained based on historic data containing information about past product orders, supplier(s) of those orders, profits associated with the orders, and the like.

In one embodiment, the present disclosure is directed to a method, which comprises: (i) receiving, by a computing system, a Material Requisition Plan (MRP) identifying a product to be procured by a manufacturer; (ii) selecting, by the computing system, a list of suppliers of the product based on the MRP; and (iii) using, by the computing system, a machine learning (ML) module to identify a pre-defined number of top-ranked suppliers from the list of suppliers based on evaluation of each supplier in the list against a plurality of business features. The ML model may be AI-based. In particular embodiments, the method further comprises using the ML module, by the computing system, to assign a supplier-specific Total Available Material (TAM) percentage for the MRP to each of the pre-defined number of top-ranked suppliers in the list.

In another embodiment, the present disclosure is directed to a computing system, which comprises: a memory storing program instructions; and a processing unit coupled to the memory and operable to execute the program instructions. In the computing system, the program instructions, when executed by the processing unit, cause the computing system to: (i) receive an MRP identifying a product to be procured by a manufacturer; select a list of suppliers of the product based on the MRP; and use an ML module to identify a pre-defined number of top-ranked suppliers from the list of suppliers based on evaluation of each supplier in the list against a plurality of business features.

In a further embodiment, the present disclosure is directed to a computer program product comprising a non-transitory computer-usable medium having computer-readable program code embodied therein, wherein the computer-readable program code is adapted to be executed by a computing system to implement a method. The method comprises: (i) receiving an MRP identifying a product to be procured by a manufacturer; (ii) selecting a list of suppliers of the product based on the MRP; and (iii) using an ML module to identify a pre-defined number of top-ranked suppliers from the list of suppliers based on evaluation of each supplier in the list against a plurality of business features.

The ML module as per teachings of the present disclosure is an AI-based analytical tool that can continuously learn from the market data and historical orders to dynamically recommend the best supplier portfolio to the manufacturer for a specific product. The limitations of a manual selection of suppliers are substantially alleviated when each supplier is rigorously and automatically evaluated against a well-designed set of business features. The uncertainties and risks associated with changes in the marketplace, supplier capabilities, delivery capacity, availability of suppliers, and the like, may be continuously monitored by the ML module to recommend a group of suppliers that is best suited to deliver the requisite product on time and in a financially-rewarding manner to the manufacturer of an information handling system.

### BRIEF DESCRIPTION OF THE DRAWINGS

A more complete understanding of the present disclosure may be obtained by reference to the following Detailed Description when taken in conjunction with the accompanying Drawings. For ease of discussion, the same reference numbers in different figures indicate similar or identical items.

FIG. 1 shows an exemplary block diagram showing how a supplier portfolio selection module as per particular embodiments of the present disclosure may be implemented.

FIG. 2 is an exemplary flowchart depicting various steps that may be performed by a computing system as per particular embodiments of the present disclosure to carry out supplier selection using the SPS module of FIG. 1.

FIG. 3 is a flowchart providing an overview of various tasks that may be performed by the SPS module of FIG. 1 as per certain embodiments of the present disclosure.

FIG. 4 shows a table with an exemplary set of business features and their attributes as per particular embodiments of the present disclosure.

FIG. 5 is an exemplary table showing supplier-specific insights that may be derived by the SPS module for each business feature shown in FIG. 4 as per particular embodiments of the present disclosure.

FIG. 6 shows a table with a column of feature-specific scores that may be generated by the SPS module for the business features shown in FIG. 4 as per certain embodiments of the present disclosure.

FIG. 7 illustrates a table with a column of feature-specific predictions that may be performed by the SPS module for the business features shown in FIG. 4 as per particular embodiments of the present disclosure.

FIG. 8 is a block diagram showing additional details of the supplier score generation by the SPS module as per certain embodiments of the present disclosure.

FIG. 9 shows an architectural overview implementing the ML-based supplier score generation aspect as per certain embodiments of the present disclosure.

FIG. 10 is an exemplary block diagram illustrating operation of the TAM generator in the SPS module of FIG. 1 as per particular embodiments of the present disclosure.

FIG. 11 illustrates an example configuration of a computer system that can be used to implement the supplier portfolio selection methodology described herein.

### DETAILED DESCRIPTION

For purpose of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, a network controller, or any other suitable device, and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, touch-screen and/or video display. The information handling system may also include one or more buses operable to transmit communications between the various hardware components.

It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor. The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism. Furthermore, a hyphenated term (e.g., “pre-defined”, “computer-readable”, “AI-based”, etc.) may be occasionally interchangeably used with its non-hyphenated version (e.g., “predefined,” “computer readable”, “AI based”, etc.), and a capitalized entry (e.g., “Supplier Database”, “Risk Score,” “Ad-hoc”, etc.) may be interchangeably used with its non-capitalized version (e.g., “supplier database,” “risk score,” “ad-hoc”, etc.). Such occasional interchangeable uses shall not be considered inconsistent with each other.

As mentioned before, in the product manufacturing/assembly environment, the supplier selection and allocation of order percentage among the selected suppliers may be carried out manually using the following three primary factors: (i) business relationship of the manufacturer with the supplier, (ii) price (per product) offered by the supplier, and (iii) capability of the supplier to supply the requested product in the ordered quantity. However, because the percentage is decided by the manufacturer/buyer manually, there would be some delay in understanding the changes in the capability of an existing supplier or analyzing the pros and cons of associating with any new supplier(s) for the same product in the marketplace. Such delay may lead to less-negotiating power to the buyers as well as risk of the unavailability of the desired product/material in a timely manner. The manufacturer/buyer may lose money on an order when such risks or uncertainties are present at the critical stage of supplier selection.

It is therefore desirable to devise a methodology to automate the supplier selection process to remove the uncertainties, delays, and risks inherent in a manual selection. It is further desirable that the automated supplier selection be adaptable to and based on the most-recent market data to provide the buyer/manufacturer with the latest information about potential suppliers and the optimum portfolio of suppliers best-suited to meet the buyer's needs.

The present disclosure relates to automated selection of suppliers based on machine learning (ML) techniques. In one embodiment, an AI-based supplier selection module (an ML module) dynamically generates TAM percentages for a group of suppliers based on the continuous learning and analysis of a set of business features. For each supplier, the ML module may evaluate many different factors such as, for example, the market value of the supplier, the capacity of the supplier to deliver the desired product, historical delivery pattern of the supplier, whether there is a new supplier in the market for the same product, the relationship of the supplier with the manufacturer, the price offered by the supplier for the product order, any payment flexibility offered by the supplier, physical proximity of the supplier to the buyer's delivery destination, and any Service Level Commitment (SLC) with the supplier. These factors may be evaluated as part of the ML module's analysis of the set of business features. Each potential supplier may be assigned a final score based on the supplier's evaluation against the set of business features. The ML module may use the supplier-specific scores to dynamically allocate TAM percentages to a pre-defined number of top-ranked suppliers to assist the manufacturer in the proper selection of suppliers for the desired product.

As noted earlier, the term “product” may be used herein to refer to a hardware component or raw material of an information handling system. For example, if the information handling system is a laptop computer, the “products” needed to manufacture or assemble a laptop computer may include hard drives (or hard disks), memory modules, motherboards, display screens, computer keyboards, and the like. Furthermore, the terms “buyer” and “manufacturer” may be used interchangeably herein to refer to a business entity that needs to select one or more suppliers for a particular product of interest. In certain embodiments, a “manufacturer” of an information handling system may not be a manufacturer in the strict sense of the word—that is, it may not manufacture each part or component of the final system. Rather, the “buyer” or “manufacturer” may be a full or part assembler of the system in the sense that it may procure necessary parts/components from different suppliers in the marketplace and assemble the procured products to make and sell the final system.

It is observed here that the ML module based supplier selection methodology as per teachings of the present disclosure may be used (with suitable modifications, if needed) for development, production, or manufacture of systems and devices other than information handling systems. The discussion below is given with reference to an information handling system as an example only.

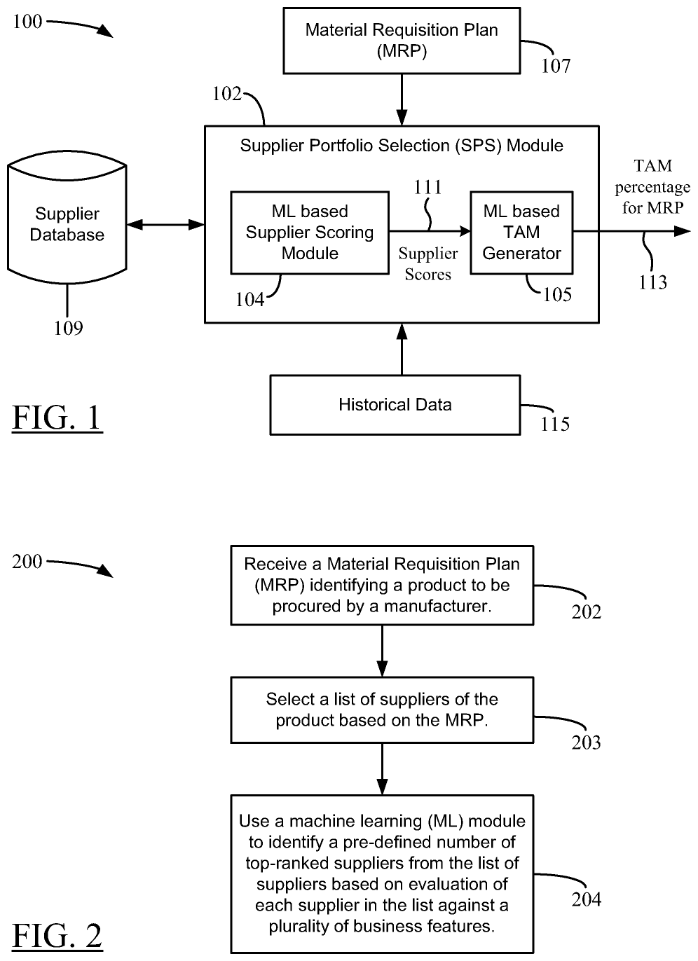

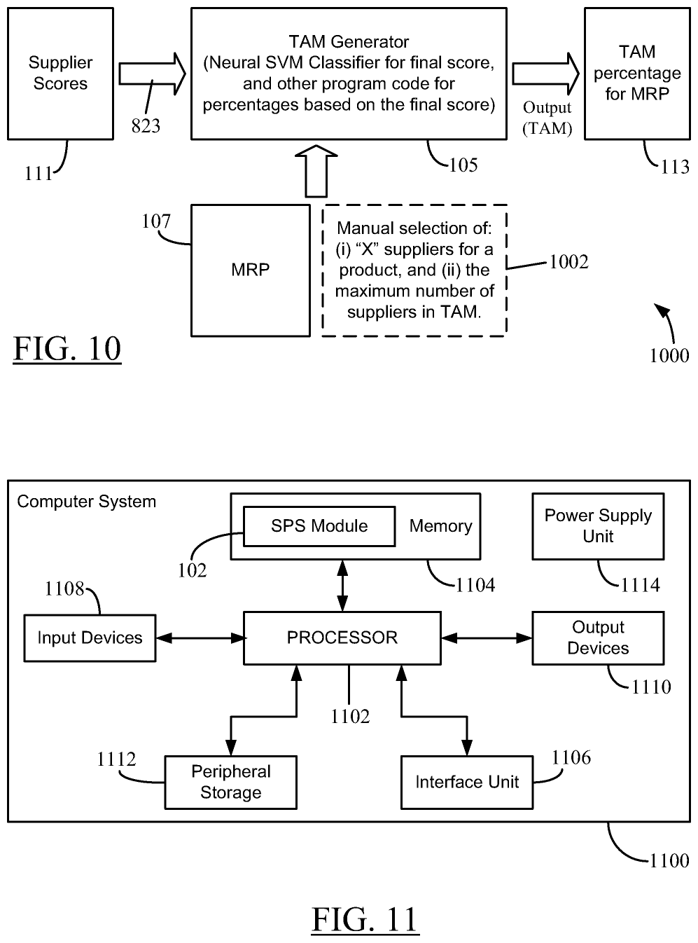

FIG. 1 shows an exemplary block diagram 100 showing how a supplier portfolio selection (SPS) module 102 as per particular embodiments of the present disclosure may be implemented. In particular embodiments, the SPS module 102 may be an AI-based software application comprising program code, which, upon execution by a processor in an information handling system (such as the processor 1102 in the computer system 1100 in FIG. 11), may cause the information handling system to perform various operational tasks discussed below with reference to FIGS. 2-10. The information handling system may be owned or operated by a buyer/manufacturer desirous of utilizing the SPS module 102 for automated selection of an optimum portfolio of suppliers. As shown in FIG. 1, the SPS module 102 may comprise two ML-based component modules—a supplier scoring module (or, simply, “scoring module”) 104, and a Total Available Material (TAM) generator module (or, TAM generator) 105. The operational details of the supplier scoring module 104 are given below with reference to FIGS. 4-9, and the functionality of the TAM generator 105 are discussed below with reference to FIG. 10.

More generally, the SPS module 102 may receive a Material Requisition Plan (MRP) 107 that identifies a product to be procured by the manufacturer. In some embodiments, a human operator/user of the computing system (not shown) running the SPS module 102 may manually input the content of the MRP 107 or may electronically transfer the content into the computing system for analysis by the SPS module 102. Based on the received MRP 107, the SPS module 102 may access a supplier database 109 to retrieve a list of suppliers of the product identified in the MRP 107. In particular embodiments, the database 109 may contain information about product-specific suppliers available in the marketplace or have been associated with the buyer in any capacity (for example, having supplied a product in the past, or having sent a quotation for an order in the past). It is understood that some suppliers may be associated with more than one product. For example, a supplier may be capable of supplying memory chips as well as hard disk drives and, hence, such a supplier may appear on product-specific supplier lists for both of these products. On the other hand, there may be only a single supplier for some highly-specialized or unique products, in which case the SPS module 102 may not perform additional analysis. In particular embodiments, the scoring module 104 may use machine learning techniques to evaluate each supplier in the product-specific list (received from the database 109) against a number of business features (discussed later) to generate feature-specific scores for each supplier in the list. These scores may be provided to the TAM generator 105 for further processing, as indicated by arrow 111 in FIG. 1. It is noted here that the reference numeral “111” may be used in the discussion below to also collectively refer to the supplier scores that are input to the TAM generator 105.

For each product-specific supplier, the TAM generator 105 may combine all feature-specific scores of the supplier to generate a supplier-specific final score and, consequently, also may rank each supplier in the list of suppliers based on the supplier-specific final score. In some embodiments, the TAM generator 105 may use machine learning to assign a supplier-specific TAM percentage for the MRP 107 to each of a pre-defined number of top-ranked suppliers in the list, as indicated at arrow 113 in FIG. 1 and discussed in more detail with reference to FIG. 10. In some embodiments, a human-decision maker or user of the SPS module-based computing system (not shown) at the buyer's facility may specify the pre-defined number (for example, three suppliers). In other embodiments, the pre-defined number may be pre-programmed into the SPS module 102. The TAM percentages may enable the human decision-maker (or another user) at the buyer's facility to select one or more suppliers for fulfilling a product order knowing that the supplier(s) have been thoroughly evaluated by the SPS module 102 for optimum performance. In this manner, the supplier selection process may be automated for prompt, successful, and profitable fulfillment of the product order specified in the MRP 107.

As shown in FIG. 1, in one embodiment, the ML-based SPS module 102 may be trained using historical data 115, which may have been stored in a database such as, for example, the supplier database 109. The historical data 115 may contain information such as, for example, details of the product orders placed in the past by the manufacturer, the portfolios of suppliers and profits associated with those product orders, and the like. The training of various ML-based classifiers and analytical tools in the scoring module 104 and TAM generator 105 may generate a trained version of the SPS module 102. In particular embodiments, the trained version of the SPS module 102 may be deployed to receive the MRP 107, obtain the product-specific list of suppliers from the database 109, and perform appropriate analyses to generate supplier scores 111 and TAM percentages (at arrow 113) as briefly discussed earlier and as also discussed in more detail later. However, for ease of discussion, the qualifier “trained” may be omitted when providing details of supplier selection by the SPS module 102 as per teachings of the present disclosure. In other words, the reference numeral “102” also may refer to the trained version of the SPS module as per teachings of the present disclosure, as may be evident from the context of discussion.

FIG. 2 is an exemplary flowchart 200 depicting various steps that may be performed by a computing system as per particular embodiments of the present disclosure to carry out supplier selection using the SPS module 102 of FIG. 1. In one embodiment, the computing system may be the system 1100 shown in FIG. 11 and discussed later below. More generally, the computing system performing the steps shown in FIG. 2 may include in hardware and/or software the functionality of the SPS module 102. In one embodiment, the program code for the SPS module 102 (and other relevant program code such as the program code for an operating system managing the execution of the module 102) may be executed by a processor (such as the processor 1102 in FIG. 11) in the computing system, and, upon execution of the program code, the computing system may be operative to perform the tasks illustrated in FIG. 2.

In the flowchart 200, each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the process shown in the flowchart 200. For discussion purpose, the process in the flowchart 200 is described with reference to FIG. 1 as described above, although other models, frameworks, systems and environments may be used to implement this process.

Initially, the computing system (for example, the computer system 1100 in FIG. 11) may receive an MRP (such as the MRP 107 in FIG. 1) identifying a product to be procured by a manufacturer/buyer, as noted at block 202. As noted earlier, the MRP may be received from a human user who may manually input the content of the MRP into the computing system or may electronically transfer the content (for example, from a different source) into the computing system. In some embodiments, the contents of the MRP 107 may be stored in a memory (such as the memory 1104) of the computing system. As noted at block 203, the computing system may select a list of suppliers of the product based on the MRP. Thereafter, the computing system may use an ML module—such as the SPS module 102 in FIG. 1—to identify a pre-defined number (for example, three) of top-ranked suppliers from the list of suppliers based on evaluation of each supplier in the list against a plurality of business features, as noted at block 204. In this manner, the computing system may perform an automated selection of an optimum set of suppliers to provide a robust choice of suppliers to the buyer/manufacturer of a specific product. This assistance in supplier selection may enable the buyer to meet its production goals and delivery commitments in a financially-rewarding manner, while significantly mitigating the market risks associated with a manual selection of suppliers.

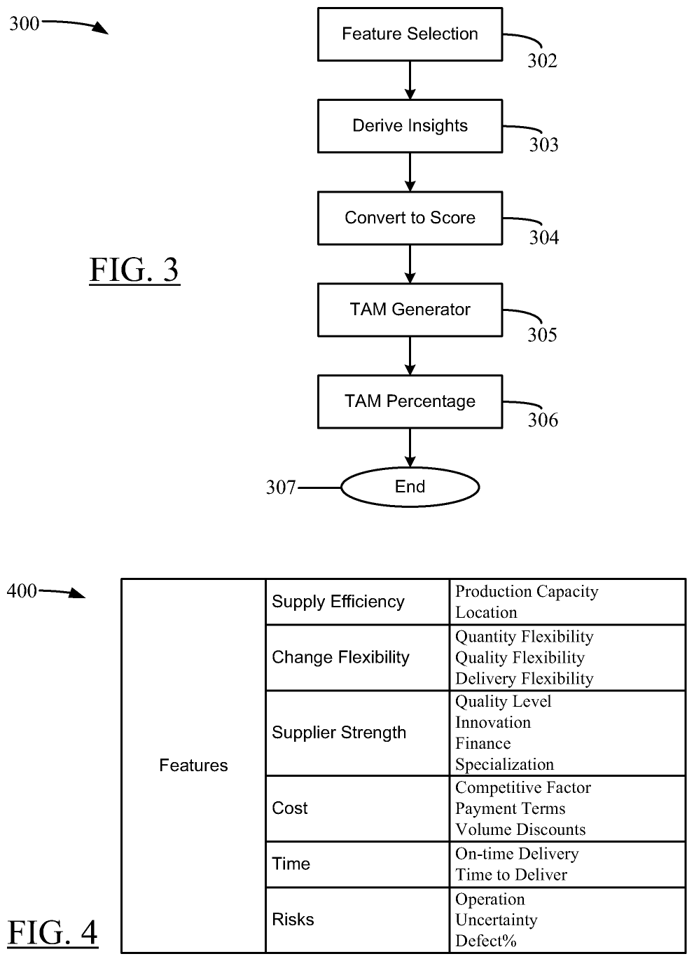

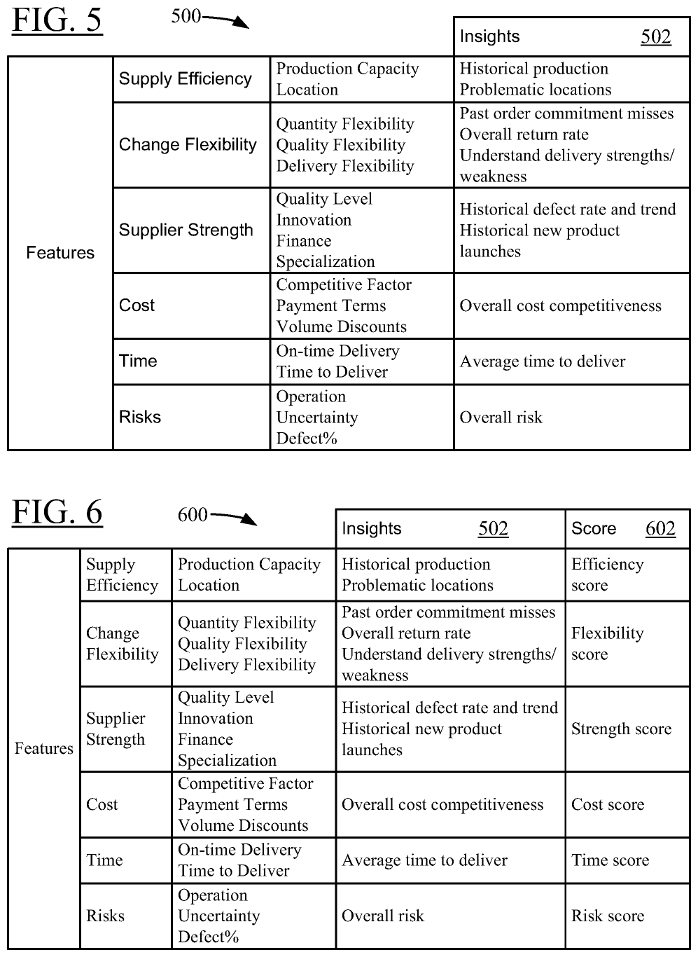

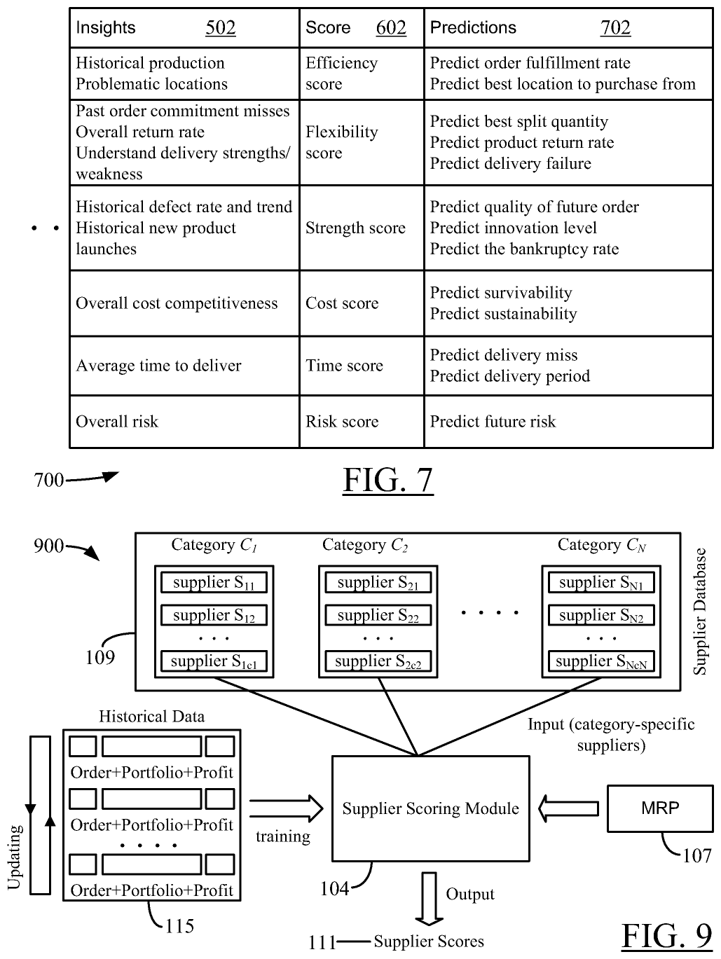

FIG. 3 is a flowchart 300 providing an overview of various tasks that may be performed by the SPS module 102 of FIG. 1 as per certain embodiments of the present disclosure. As mentioned before, the supplier selection as per teachings of the present disclosure may involve evaluation of each supplier against a set of business features. The aspect of feature selection (by the SPS module 102) is noted at block 302. An exemplary set of business features that may be considered by the SPS module 102 as part of supplier evaluation is shown in FIG. 4 and discussed later below. Generally, the selected set of features may evaluate each supplier against three generic attributes: quality, cost, and time. For example, the quality attribute may relate to the defects in the products received from the supplier, and the reputation of the supplier as it relates to the quality of the product of interest. The cost attribute may primarily address the pricing offered by the supplier in fulfilling the ordered quantity of products. The time attribute, on the other hand, may relate to a supplier's reputation for on-time delivery of a product, as well as the actual time the supplier takes (or has taken in the past) to deliver the product. The selected business features may enable the SPS module 102 to derive further insights into a supplier's suitability for fulfilling a particular product order (block 303). Exemplary feature-specific insights are discussed later with reference to FIG. 5. The SPS module 102—more specifically, the scoring module 104—may convert the feature evaluations and corresponding insights into a set of feature-specific scores for each supplier, as indicated at block 304. A set of exemplary scores is shown in FIG. 6 and discussed later below. Additional details of supplier scoring are provided later with reference to FIG. 9. As noted at block 305, the scores of each supplier may be provided to the TAM generator module 105 (as also shown at arrow 111 in FIG. 1), which may generate TAM percentages for a pre-defined number of top-ranked suppliers (block 306). The TAM percentages may assist the buyer in selecting a group of suppliers (or a supplier portfolio) that have been thoroughly evaluated and found to be the most-desirable for the MRP 107 under consideration. The functionality of the TAM generator 105 is discussed later with reference to FIG. 10. The process in FIG. 3 may terminate at block 307.

FIG. 4 shows a table 400 with an exemplary set of business features and their attributes as per particular embodiments of the present disclosure. The scoring module 104 of the SPS module 102 may use machine learning techniques to evaluate each potential supplier of a product (such as, for example, the product identified in the MRP 107) against these business features to generate a feature-specific score for each supplier. The business features shown in the table 400 are illustrative only; additional or different features may be considered as per business requirements. In particular embodiments, the scoring module 104 may be programmed with or trained to select these business features as part of the feature selection task noted at block 302 in FIG. 3. As shown in FIG. 4, in one embodiment, these business features include: (i) a supply efficiency feature indicating how efficiently a supplier can supply the product; (ii) a change flexibility feature indicating how flexible a supplier is as to quantity, quality, and delivery of the product; (iii) a supplier strength feature indicating financial and innovation strength of a supplier; (iv) a cost feature indicating overall cost competitiveness of a supplier; (v) a time feature indicating an average time a supplier takes to deliver the product; and (vi) a risks feature indicating an overall product delivery risk associated with a supplier.

As shown in FIG. 4, the attributes of the supply efficiency feature may include: (i) the production capacity of the supplier, and (ii) the physical location from which the requested product may be supplied by the supplier. The attributes of the change flexibility feature may include: (i) a measure of the supplier's flexibility as to the quantity of the ordered product, (ii) a measure of the supplier's flexibility as to the quality of the ordered product, and (iii) a measure of the supplier's flexibility as to the delivery schedule of the ordered product. The attributes of the supplier strength feature may include: (i) quality level of the supplier's products, (ii) whether the supplier engages in innovation, (iii) the financial strength of the supplier, and (iv) whether the supplier specializes in any product(s). The attributes of the cost feature may include: (i) how competitive is the supplier's quote for the current order and/or for another order of the same product in the past, (ii) the payment terms offered by the supplier currently and/or in the past, and (iii) any volume discounts offered by the supplier for the current order or any other order in the past. The attributes of the time feature may include: (i) on-time delivery record of the supplier or whether the supplier has a reputation for on-time delivery, and (ii) the time indicated by the supplier to deliver the requested product order—whether in a single shipment or in multiple batches, or the time the supplier had indicated for a similar product/order in the past. The attributes of the risks feature may include: (i) risks associated with the supplier's production operation, (ii) uncertainty associated with the supplier's delivery of the product or its delivery schedule, and (iii) the percentage of defective products expected from the supplier or the average percentage of products expected to be defective in the relevant industry.

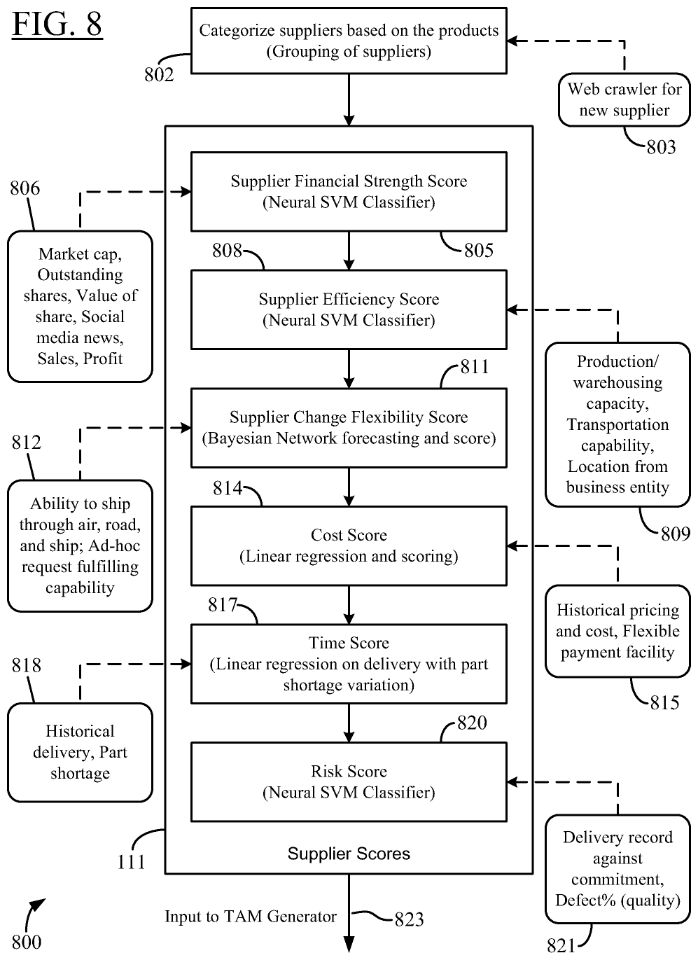

It is observed that the scoring module 104 may obtain the information necessary to evaluate various business features and their attributes from a combination of different sources including, for example, any historical data stored in the supplier database 109 related to previous business dealings of the supplier with the manufacturer, any business quotes or delivery information provided by a supplier in response to the MRP 107 having been shared with the supplier prior to the selection of suppliers using the SPS module 102, any information obtained through online market research (as discussed with reference to FIG. 8 later), prior insights (discussed below with reference to FIG. 5) and predictions (discussed later with reference to FIG. 7) that may have been stored in a database (such as the supplier database 109), inferences and contents learned during the training of the SPS module 102, and the like.

FIG. 5 is an exemplary table 500 showing supplier-specific insights that may be derived by the SPS module 102 for each business feature shown in FIG. 4 as per particular embodiments of the present disclosure. The task of deriving insights is indicated by block 303 in FIG. 3. In one embodiment, the scoring module 104 of the SPS module 102 may use a neural network to perform this task and derive feature-specific insights, some examples of which are provided in column 502 in FIG. 5. In evaluating a supplier against a business feature and its attributes, the scoring module 104 may derive certain insights as part of the evaluation that may assist the scoring module 104 in subsequent generation of feature-specific scores for the supplier. As shown in FIG. 5, the insights that may be derived for the supply efficiency feature may include: (i) historical production of the product (identified in the MRP 107) by the supplier, and (ii) any production location(s) of the supplier that may be problematic (for example, physically too far from the buyer's delivery destination, or operationally incapable of meeting the buyer's demand) if the supplier were selected to deliver some or all of the product order. The insights that may be derived for the change flexibility feature may include: (i) if the supplier has missed any order commitments in the past, (ii) the overall return rate of the products supplied by the supplier, and (iii) an understanding of the delivery strength/weakness of the supplier as it relates, for example, to the quantity, quality, and delivery schedule of the product of interest. The insights that may be derived for the supplier strength feature may include: (i) historical defect rate and defect trend for the products received from the supplier, (ii) historical new product launches by the supplier. The insight that may be derived for the cost feature may be the overall cost competitiveness of the supplier. In case of the time feature, the derived insight may be the average time the supplier usually takes to deliver an assigned order of products. For the risks feature, the derived insight may be the overall product delivery risk associated with a supplier.

FIG. 6 shows a table 600 with a column of feature-specific scores that may be generated by the SPS module 102 for the business features shown in FIG. 4 as per certain embodiments of the present disclosure. In the table 600 in FIG. 6, the column of scores is identified with the reference numeral “602” and is shown added to the other columns already illustrated in the table 500 in FIG. 5. The score generation aspect is indicated by block 304 in FIG. 3. In one embodiment, the scoring module 104 of the SPS module 102 may use a neural network to generate a set of feature-specific scores for each supplier under consideration with reference to the product specified in the MRP 107. In the ML-based analysis and processing, a business feature, its attributes, and corresponding insights may assist the scoring module 104 in arriving at a feature-specific score. In the context of FIG. 1, such feature-specific scores for all suppliers are collectively identified through the reference numeral “111.” In the embodiment of FIG. 6, for each supplier, the following set of scores may be generated by the scoring module 104: (i) an efficiency score associated with the supply efficiency feature, (ii) a flexibility score associated with the change flexibility feature, (iii) a strength score associated with the supplier strength feature, (iv) a cost score associated with the cost feature, (v) a time score associated with the time feature, and (vi) a risk score associated with the risks feature. Additional details about generation of feature-specific scores are given later with reference to FIG. 8.

FIG. 7 illustrates a table 700 with a column of feature-specific predictions that may be performed by the SPS module 102 for the business features shown in FIG. 4 as per particular embodiments of the present disclosure. In the table 700 in FIG. 7, the column of predictions is identified with the reference numeral “702” and is shown added to the other columns already illustrated in the table 600 in FIG. 6. For ease of illustration, only the relevant columns of the table 700 are shown in FIG. 7; the columns that are not shown are identical to those in the table 600 in FIG. 6. In the column 702, exemplary predictions for each corresponding business feature are listed. In some embodiments, the aspect of generation of predictions may be a part of the score generation block 304 in FIG. 3. In one embodiment, the scoring module 104 of the SPS module 102 may use a neural network to generate a set of feature-specific predictions for each supplier. In the ML-based analysis and processing as per certain embodiments of the present disclosure, each business feature, its attributes, and corresponding insights, scores, and predictions may be assigned respective numerical values not only to facilitate supplier evaluation, but also to assist the TAM generator 105 in arriving at a supplier-specific TAM percentage (discussed later below) for the MRP 107.

In the context of FIG. 7, for each supplier, the following predictions may be provided by the scoring module 104. For the supply efficiency feature, the predictions may include: (i) a prediction of order fulfillment rate of the supplier if the supplier were chosen to fulfill a part or whole of the product order specified in the MRP 107, and (ii) a prediction as to the best location of the supplier from which the product should be purchased. For the change flexibility feature, the predictions may include: (i) a prediction as to how to best split the quantity of the ordered product to enable the supplier to fulfill its portion of the overall order in stages, (ii) a prediction of the overall product return rate for this supplier, and (iii) a prediction of whether the delivery of the assigned batch of products from the supplier would fail or succeed. For the supplier strength feature, the predictions may include: (i) a prediction of the quality of the products to be provided by the supplier in the current or future order, (ii) a prediction of the innovation level at the supplier's organization or product development facility, and (iii) a prediction if the supplier is a candidate for bankruptcy or a prediction of the bankruptcy rate attributable to the supplier. For the cost feature, the predictions may include: (i) a prediction of survivability of the supplier in the marketplace, and (ii) a prediction of whether the supplier can sustain its competitiveness in the marketplace. For the time feature, the predictions may include: (i) a prediction of the chance of the supplier missing the product delivery deadline, and (ii) a prediction of the order delivery period (or time the supplier may take to deliver the ordered products). For the risks feature, the scoring module 104 may predict the future risk of (or related to) product delivery if the supplier were selected to fulfill some or all of the product order.

FIG. 8 is a block diagram 800 showing additional details of the supplier score generation by the SPS module 102 as per certain embodiments of the present disclosure. Various feature-specific scores for a supplier are already shown in FIGS. 6-7. The block diagram 800 in FIG. 8 illustrates factors that may be considered—for example, by the scoring module 104 of the SPS module 102—while generating a feature-specific score, and the ML technique/model (such as, for example, neural network, Bayesian network, linear regression, and the like) that may be used to generate the respective score. As noted at block 802, all of the suppliers associated with the buyer/manufacturer may be categorized based on the products. In other words, in one embodiment, the suppliers—whose information may be stored in the supplier database 109—may be grouped into product-specific categories by the scoring module 104. For example, if the information handling system is a laptop computer, the “products” needed to manufacture or assemble a laptop computer may include hard drives (or hard disks), memory modules, motherboards, display screens, computer keyboards, and the like. In that case, the relevant suppliers may be categorized into such product-specific categories as, for example, memory suppliers, motherboard suppliers, display suppliers, and so on. In some embodiments, as noted at block 803, the scoring module 104 also may utilize a web crawler to perform a routine (or periodic) online search for entry of new supplier(s) in the market for one or more of the product categories. The information obtained through such online searches may allow the scoring module 104 to periodically update/amend the existing list of product-specific suppliers (for example, in the supplier database 109) and, hence, to analyze a most up-to-date list of suppliers when processing the MRP 107 for the buyer's product.

For the sake of consistency and ease of discussion, the block representing all of the supplier-specific scores in FIG. 8 (and also in FIG. 10) is identified using the same reference numeral “111” as that used in FIG. 1 (and also in FIG. 9) to collectively refer to all supplier scores. In FIG. 8, the supplier scores 111 include the scores shown at blocks 805, 808, 811, 814, 817, and 820. Referring now to block 805, in one embodiment, the scoring module 104 may use a neural network-based Support Vector Machine (SVM) classifier to generate the supplier financial strength score (or, simply, the “strength score” in column 602 in FIGS. 6-7). The SVM classifier may not only process the supplier strength feature-specific attributes shown in FIG. 5, but also may process the exemplary content shown at block 806—such as, for example, the market capitalization (market cap) of the supplier, the number of outstanding share (if any) of the supplier, the current value of each share of the supplier, any positive/negative news about the supplier in the social media, the prior sales and profit data of the supplier (if available) over a specific number of years, and so on. Based on the evaluation of all such information from different sources (online and off-line), the scoring module 104 may generate the supplier strength score 805.

Referring now to block 808, in one embodiment, the scoring module 104 may use the above-mentioned neural network-based SVM classifier to generate the supplier efficiency score (also listed in column 602 in FIGS. 6-7). The SVM classifier may not only process the supply efficiency feature-specific attributes shown in FIG. 5, but also may process the exemplary content shown at block 809—such as, for example, the production and/or warehousing capacity of the supplier, the transportation capability of the supplier, the proximity of the supplier's location from which the product (in the MRP 107) may be supplied to the business entity requesting the product (here, the buyer or manufacturer associated with the MRP 107), and so on. Based on the evaluation of all such information from one or more sources (online and/or off-line), the scoring module 104 may generate the supplier efficiency score 808. In case of the block 811, in one embodiment, the scoring module 104 may use the Bayesian network-based forecasting and scoring to generate the supplier change flexibility score (or, simply, the “flexibility score” in column 602 in FIGS. 6-7). The Bayesian network may not only process the supplier change flexibility feature-specific attributes shown in FIG. 5, but also may process the exemplary content shown at block 812—such as, for example, the supplier's ability to ship a product shipment through air, road, and water transport; the supplier's capability to fulfill a product order sent to the supplier on an ad-hoc (or last-minute) basis; and so on. Based on the evaluation of such information from one or more sources (online and/or off-line), the scoring module 104 may generate the supplier change flexibility score 811.

In the context of block 814, in one embodiment, the scoring module 104 may use the linear regression based scoring to generate the cost score (also listed in column 602 in FIGS. 6-7). The linear regression model may not only process the supplier cost feature-specific attributes shown in FIG. 5, but also may process the exemplary content shown at block 815—such as, for example, the historical pricing and cost quoted by the supplier on past orders of the same product from the current buyer or the historical pricing quoted to other buyers in the marketplace (if such information is available), any flexible payment options (such as, for example, payment after 60 days, or payment over three equal installments over six months, and the like) available from the supplier (currently or in the past), and so on. Based on the evaluation of such information from different sources (online and off-line), the scoring module 104 may generate the cost score 814.

For the time score at block 817, in one embodiment, the scoring module 104 may use the above-mentioned linear regression model to analyze the supplier's delivery behavior to generate the supplier-specific time score (also listed in column 602 in FIGS. 6-7). In one embodiment, the linear regression model also may address any data related to part shortage variations. For example, in case of certain products, the buyer may have experienced in the past (or may experience in the future) shortages of parts or product replacements for the products received from the supplier. Variations in such shortages over a specific period may be considered for analysis. The linear regression model may not only process the time feature-specific attributes shown in FIG. 5, but also may process the exemplary content shown at block 818—such as, for example, the historical delivery timings of the supplier for the past shipments (if any), any part shortages or variations in the supply of replacement parts and the timings of supplier's responses to ameliorate such shortages/variations, and so on. Based on the evaluation of such timing-related information from one or more sources (online and/or off-line), the scoring module 104 may generate the time score 817.

Referring now to block 820, in one embodiment, the scoring module 104 may use the earlier-mentioned neural network-based SVM classifier to generate the risk score (also listed in column 602 in FIGS. 6-7). The SVM classifier may not only process the risks feature-specific attributes shown in FIG. 5, but also may process the exemplary content shown at block 821—such as, for example, a measurement of the supplier's prior delivery record against its commitment (for example, as to the product quantity or quality), the percentage of products from the supplier with defective quality, and so on. Based on the evaluation of all such information from one or more sources (online and/or off-line), the scoring module 104 may generate the supplier-specific risk score 820.

The score generation shown in FIG. 8 may be carried out for each supplier under consideration for the MRP 107. As noted, in some embodiments, all product-specific suppliers grouped at block 802 may be evaluated and scored in this manner. The block 111 in FIG. 8 represents all feature-specific scores for a supplier. Such scores for all suppliers under consideration for the MRP 107 may be input to the TAM generator 105, as indicated by arrow 823 in FIG. 8 (and also shown in FIG. 10). The eventual allocation of TAM percentage to a pre-defined number of top-ranked suppliers as per certain embodiments is discussed later with reference to FIG. 10.

FIG. 9 shows an architectural overview 900 implementing the ML-based supplier score generation aspect as per certain embodiments of the present disclosure. As noted before, in particular embodiments, the ML-based supplier scoring module 104 may generate a set of feature-specific scores 111 for each supplier under consideration for a specific product order or MRP 107. As shown in FIG. 9, in one embodiment, the scoring module 104 may be initially (and, preferably, continually) trained using the historical data 115 before the scoring module 104 is deployed to generate scores for the suppliers associated with the MRP 107. In one embodiment, the training process may be dynamically performed in the background every time the historical dataset 115 is updated with new data. As noted before with reference to FIG. 1, the historical data 115 may have been stored in a database such as, for example, the supplier database 109. In the embodiment of FIG. 9, the historical data 115 is shown as a plurality of order-specific performance datasets, wherein each dataset may contain information such as, for example, details of the product orders placed in the past by the buyer/manufacturer, the portfolios of suppliers associated with those product orders, and the profits reported for those product orders. In other embodiments, additional or different information may be stored as part of the historical data 115.

As shown in FIG. 9, the historical data 115 may be continually updated as new product orders are placed and corresponding new information about related supplier portfolios and profits become available. The training of the scoring module 104, in turn, may be similarly updated to provide a robustly trained scoring module. The training of various ML-based classifiers and analytical tools in the scoring module 104 may generate a trained version of the scoring module 104. In particular embodiments, the trained version of the scoring module 104 may be deployed to receive the MRP 107, obtain the product-specific list of suppliers from the database 109, and perform appropriate analyses to generate supplier scores 111. As an example, during the training phase, a neural network based classifier (such as the SVM classifier discussed with reference to blocks 805, 808, and 820 in FIG. 8 before) may be supervised to learn from the training data by presenting the training data at an input layer and dynamically adjusting the parameters of the neural network to achieve the desired output value for the input set using, for example, back-propagation of the error from the output of one stage to the input of the next stage, where weights are changed continuously until the output error falls below a preset value. In this manner, a neural network model may learn correlated patterns between input data sets and the corresponding target values. This enables the neural network model to predict an output when presented with a new, unseen input at run time. Similar training may be carried out for other ML models of the scoring module 104 discussed with reference to FIG. 8. Although the discussion below (related to generation of supplier scores) is with reference to a trained version of the scoring module 104, for ease of discussion, the qualifier “trained” may be omitted when providing details of supplier score generation by the scoring module 104. In other words, the reference numeral “104” also may refer to the trained version of the scoring module as per teachings of the present disclosure, as may be evident from the context of discussion.

The scoring module 104 may analyze the received MRP 107 to determine the category of the product specified therein. As shown in FIG. 9, the supplier database 109 may store a list of suppliers for each category of products associated with the buyer/manufacturer including, for example, any product ever purchased by the buyer in the past or to be purchased in the future. As mentioned before, for a buyer, the “products” needed to manufacture or assemble a laptop computer may include hard drives (or hard disks), memory modules, motherboards, display screens, computer keyboards, and the like. In that case, the relevant suppliers (past or current) may be categorized into such product-specific categories as, for example, memory suppliers, motherboard suppliers, display suppliers, and so on. Thus, by way of an example, the category C₁ in the supplier database 109 in FIG. 9 may include all suppliers of computer memories (suppliers S₁₁ through S_{1c1}), the category C₂ in the supplier database 109 may include all suppliers of computer hard drives (suppliers S₂₁ through S_{2c2}), and so on. In a similar manner, suppliers for products of other categories also may be identified in the database 109. It is observed here that some suppliers may appear in more than one category. For example, a supplier who has supplied or who can supply memory modules as well as hard drives may be listed under categories C₁ and C₂ both. In certain embodiments, the creation of product-specific categories and the categorized storage of supplier information may be performed by the scoring module 104 itself based on, for example, reception and analysis of the historical data 115 during training. In other embodiments, the scoring module 104 (or the SPS module 102 in general) may provide an option for a human user at a buyer's site to create such category-specific grouping of suppliers in the database 109. In some other embodiments, the database management system operating and managing the supplier database 109 may itself categorize and store the supplier information as part of creating and maintaining the supplier database 109. Other approaches to creation and storage of category-specific supplier lists may be devised. The grouping of suppliers into product-specific groups is also identified at block 802 in FIG. 8.

As shown in the embodiment of FIG. 9, the scoring module 104 may be in communication with or may be able to access the supplier database 109 to select/retrieve category-specific list of suppliers therefrom based on the category of the product specified in the MRP 107. In one embodiment, a list of all suppliers associated with a specific category may be sent as an input to the scoring module 104. In another embodiment, a user may be allowed to select a certain number of suppliers such as, for example, the five most active suppliers, or the five most-recent suppliers ranked in chronological order of their interaction with the buyer, or only those suppliers who are associated with multiple categories, and the like. The scoring module 104 may evaluate each supplier in the list of category-specific suppliers received from the supplier database 109 and generate a set of feature-specific scores 111 for each supplier in the list. The details of evaluation of suppliers and generation of supplier scores 111 are already provided before with reference to discussion of FIGS. 1-8.

FIG. 10 is an exemplary block diagram 1000 illustrating operation of the TAM generator 105 in the SPS module 102 of FIG. 1 as per particular embodiments of the present disclosure. In one embodiment, the TAM generator 105 may use a neural network-based SVM classifier to generate a final score for each supplier (as discussed later). The training of such ML-based classifier and other analytical tools in the TAM generator 105 may be performed in a manner similar to the training of the ML-based classifiers and analytical tools in the scoring module 104 to generate a trained version of the TAM generator 105, which may be deployed to generate the TAM percentages 113. For example, the neutral network based classifier in the TAM generator 105 may be trained based on historic supplier scores, corresponding MRPs, and resulting TAM percentages. In certain embodiments, the training also may include additional supplier information (such as, for example, supplier information specific to certain business features of interest) retrieved from the supplier database 109 or supplier information derived by the scoring module 104 (such as, for example, business feature-specific predictions for a supplier) to equip the TAM generator 105 to more accurately assign TAM percentages to relevant suppliers. Although the discussion below (related to generation of TAM percentage) is with reference to a trained version of the TAM generator 105, for ease of discussion, the qualifier “trained” may be omitted when providing details of generation of TAM percentages by the TAM generator 105. In other words, the reference numeral “105” also may refer to the trained version of the TAM generator as per teachings of the present disclosure, as may be evident from the context of discussion. In one embodiment, the trained versions of the scoring module 104 and the TAM generator 105 may constitute the trained version of the SPS module 102.

In one embodiment, for each supplier in the list of suppliers evaluated by the scoring module 104, the TAM generator 105 may combine all feature-specific scores of the supplier (received at arrow 823 in FIG. 10) to generate a supplier-specific final score. For example, in one embodiment, the final score for a supplier may be a simple addition of all feature-specific scores generated for the supplier. In another embodiment, each feature-specific score may be assigned a weight, and the final score may be a weighted addition of all feature-specific scores for the supplier. Furthermore, in certain embodiments, the TAM generator 105 also may rank each supplier in the list (from the highest rank to the lowest rank) based on the supplier-specific final score and identify/recommend a pre-defined number of top-ranked suppliers that may be considered by the buyer/manufacturer to fulfill the product order in the MRP 107. In one embodiment, this pre-defined number may be automatically determined by the TAM generator 105 and may include all or a subset of the suppliers in the list of ranked suppliers. In another embodiment, a user may be allowed to specify this pre-defined number as discussed below with reference to block 1002 in FIG. 10.

As shown in FIG. 10, in one embodiment, a user may be allowed to include—for example, as part of the MRP 107—additional information listed in block 1002. Because of the optional nature of such information, the block 1002 is shown using a dashed line. In one embodiment, the TAM generator 105 may provide an on-screen option for the user to manually input such additional information or provide a set of on-screen data fields to the user to allow the user to select appropriate choices representing the additional information the user wishes to input to the TAM generator 105 for consideration during generation of TAM percentages 113. As shown in block 1002, for example, the user may manually provide: (i) a list of “X” (for example, five) preferred suppliers of the product (specified in the MRP 107), and (ii) the maximum number of suppliers (for example, three) from the list of “X” preferred suppliers that may be assigned the TAM percentage by the TAM generator 105. For example, the user may input to the TAM generator 105 the names or other identifiers of the “X” preferred suppliers that the TAM generator may need to rank based on their respective final scores. In this approach, the TAM generator 105 may not need to generate final scores for all of the suppliers whose individual feature-specific scores have been received (at arrow 823) from the scoring module 104, but for only those “X” suppliers that are specified by the user at block 1002. In one embodiment, a user-specified number of suppliers—from these “X” ranked suppliers—may be assigned respective TAM percentages (discussed below). In particular embodiments, the suppliers with TAM percentages may represent the earlier-mentioned pre-defined number of top-ranked suppliers that may be considered by the buyer/manufacturer to fulfill the product order in the MRP 107.

Thus, in the embodiment of FIG. 10, the TAM generator 105 may include program code to assign a supplier-specific TAM percentage for the MRP 107 to each of a pre-defined number of top-ranked suppliers from the list of suppliers evaluated by the scoring module 104 or specified by the user as the list of “X” preferred suppliers. In the latter case, for example, the user may specify five preferred suppliers (as part of the input at block 1002) and may instruct the TAM generator 105 to assign TAM percentage to the top three of these five preferred suppliers. It is noted here that, in some embodiments, TAM percentages may be generated because a simple, score-based ranking of the suppliers may not be sufficient to provide a more accurate recommendation of suppliers to the buyer. For example, a supplier may have the highest score, yet it does not necessarily imply that the supplier is capable of supplying 100% of the ordered products. Furthermore, commercially, it may not be even desirable to rely on a single supplier for the entire product order, unless there is no other option such as, for example, when a unique product is involved and the supplier is the only provider in the marketplace. Therefore, it may be desirable to utilize the TAM generator 105 to assign TAM percentage to a selected number of top-ranked suppliers to identify an optimum portfolio of suppliers that can fulfill the requirements of the MRP 107. For example, in the earlier example related to block 1002, the user may identify five preferred suppliers X₁-X₅ to the TAM generator 105. Based on the supplier-specific scores received at arrow 823, these preferred group of suppliers may be ranked by the TAM generator 105 in the following order (from the highest-ranked to the lowest-ranked): X₂, X₅, X₁, X₄, and X₃. Thereafter, the TAM generator 105 may assign TAM percentages to the three top-ranked suppliers X₂, X₅, and X₁. For example, out of a total of 100%, the supplier X₂ may receive a TAM percentage of 37%, the supplier X₅ may receive a TAM percentage of 42%, and supplier X₁ may receive a TAM percentage of 21%, indicating the percentage of the total order (in the MRP 107) each of these suppliers should be allowed to fulfill. In this manner, the TAM generator 105 may recommend an optimum portfolio of suppliers to the buyer.

In particular embodiments, along with the supplier scores, the TAM generator 105 also may consider the feature-specific predictions for a supplier (such as those listed in column 702 in FIG. 7) in generating a supplier-specific TAM percentage. In other embodiments, additional factors such as, for example, market updates or recent market intelligence, any special instructions received from the buyer regarding one or more suppliers or the MRP fulfillment process, and the like, may be considered as well by the TAM generator 105 in assigning supplier-specific TAM percentages.

FIG. 11 illustrates an example configuration of a computer system 1100 that can be used to implement the supplier portfolio selection methodology described herein. In particular embodiments, the SPS module 102 may be used to implement the supplier portfolio selection methodology as per teachings of the present disclosure. The computer system (or computing device) 1100 may be suitably configured to implement the functionality of the SPS module 102. The computer system 1100 may include one or more processors 1102, a memory unit 1104, an interface unit 1106 providing communication interfaces, one or more input devices 1108, one or more output devices 1110, and a peripheral storage unit 1112, connected to the processor 1102 as shown and configured to communicate with each other, such as via one or more system buses (not shown) or other suitable connection. In some embodiments, the computer system 1100 may be an information-handling system mentioned before.

In one embodiment, the input devices 1108 may provide user inputs—such as user inputs received at blocks 107 and 1002 in FIG. 10—to the processor 1102 and the SPS module 102 for further processing as per teachings of the present disclosure. The input devices 1108 may include, for example, a touchpad, a camera, a computer keyboard, a touch-screen, a joystick, a physical or virtual “clickable button,” a computer mouse/pointing device, and the like. A display screen is an example of the output device 1110. Other examples of an output device include a graphics/display device, a computer screen or monitor, an alarm system, or any other type of data output device. In some embodiments, the input device(s) 1108 and the output device(s) 1110 may be coupled to the processor 1102 via an I/O or peripheral interface(s). In some embodiments, the computer system 1100 may include more than one instance of the devices shown. In various embodiments, all of the components shown in FIG. 11 may be housed within a single housing. In other embodiments, the computer system 1100 may not include all of the components shown in FIG. 11. Furthermore, the computing device 1100 may be configured as a standalone system, as a server system, as a client system, or in any other suitable form factor.

The processor 1102 is a hardware device that may include a single processing unit or a number of processing units, all of which may include single or multiple computing units or multiple cores. When the computing device 1100 is a multiprocessor system, there may be more than one instance of the processor 1102 or there may be multiple processors coupled to the processor 1102 via their respective interfaces (not shown). The processor 1102 may include an integrated Graphics Processing Unit (GPU) or the GPU may be a separate processor device in the system 1100. The processor 1102 may be implemented as one or more microprocessors, microcomputers, microcontrollers, Digital Signal Processors (DSPs), Central Processing Units (CPUs), Graphics Processing Units (GPUs), state machines, logic circuitries, and/or any devices that manipulate signals based on operational instructions. Among other capabilities, the processor 1102 may be configured to fetch and execute computer-readable instructions stored in the memory 1104, the peripheral storage 1112, or other computer-readable media. In some embodiments, the processor 1102 may be a System on Chip (SoC).

The memory 1104 and the peripheral storage unit 1112 are examples of non-transitory computer media (e.g., memory storage devices) for storing instructions that can be executed by the processor 1102 to perform the various functions described herein. For example, the memory unit 1104 may include both volatile memory and non-volatile memory (e.g., RAM, ROM, or the like) devices. Further, in particular embodiments, the peripheral storage unit 1112 may include one or more mass storage devices such as, for example, hard disk drives, solid-state drives, removable media, including external and removable drives, memory cards, flash memory, floppy disks, optical disks (e.g., CD, DVD), a storage array, a network attached storage, a storage area network, or the like. Both memory 1104 and mass storage devices constituting the peripheral storage 1112 may be collectively referred to as memory or computer storage media herein, and may be a media capable of storing computer-readable, processor-executable program instructions as computer program code that can be executed by the processor 1102 as a particular machine configured for carrying out the operations and functions described in the implementations herein.

The computing device 1100 may also include one or more communication interfaces as part of its interface unit 1106 for exchanging data via a network. The communication interfaces can facilitate communications within a wide variety of networks and protocol types, including wired networks (e.g., Ethernet, Digital Subscriber Loop (DSL), Data Over Cable Service Interface Specification (DOCSIS), Fiber Optics network, Universal Serial Bus (USB), etc.) and wireless networks (e.g., Wireless Local Area Network (WLAN), Global System for Mobile Communications (GSM), Code Division Multiple Access (CDMA), Institute of Electrical and Electronics Engineers (IEEE) standard 802.11, Bluetooth®, Wireless USB, cellular, satellite, etc.), the Internet, and the like. Communication interfaces in the interface unit 1106 can also provide communication with external storage (not shown), such as in a storage array, network attached storage, storage area network, one or more databases (such as the supplier database 109 in FIG. 1 when implemented as an external storage), or the like.

The computer storage media, such as the memory 1104 and the mass storage devices in the peripheral storage 1112, may be used to store software and data. For example, the computer storage media may be used to store the operating system (OS) for the computing device 1100, various device drivers for the device 1100, various inputs provided by the user during the implementation and operation of the SPS module 102, and the data such as audio content, video content, text data, streaming content, historical data 115 shown in FIG. 1, various supplier-specific data discussed with reference to FIGS. 1-10, or any other type of content. In some embodiments, the supplier database 109 (FIG. 1) may be a part of the peripheral storage 112. In other embodiments, the supplier database 109 may be included as part of the system memory 1104. The computer storage media also may store software applications such as a word processing application, a spreadsheet application, the SPS module 102, and the like. The program code for the software applications and the OS may be executed by the processor 1102.

In one embodiment, a non-transitory, computer-readable data storage medium, such as, for example, the system memory 1104 or the peripheral data storage unit 1112 may store program code or software for the SPS module 102 as per particular embodiments of the present disclosure. In the embodiment of FIG. 11, the system memory 1104 is shown to include such program code. In the embodiment of FIG. 11, the SPS module 102 may operate in conjunction with the host OS (not shown) of the computing device 1100. The processor 1102 may be configured to execute the program code for the SPS module 102, whereby the computer system 1100 may be operative to perform various tasks associated with the SPS module 102 as per the teachings of the present disclosure. In one embodiment, such tasks may include, for example, the process steps illustrated in FIGS. 2-3 as well as other tasks discussed with reference to FIGS. 1 and 4-10 such as, for example, training of the SPS module 102, reception of MRP 107 and historical data 115, evaluation of suppliers against a set of business features, generation of supplier scores and predictions, ranking of suppliers and allocation of TAM percentages to a pre-defined number of top-ranked suppliers, and so on. The program code or software for the SPS module 102 may be proprietary software or open source software which, upon execution by the processor 1102, may enable the computer system 1100 to perform operations related to supplier selection and TAM allocation as per teachings of the present disclosure.

In particular embodiments, the computing device 1100 may include an on-board power supply unit 1114 to provide electrical power to various system components illustrated in FIG. 11. The power supply unit 1114 may receive batteries or may be connectable to an AC electrical power outlet. In one embodiment, the power supply unit 1114 may convert solar energy or other renewable energy into electrical power.

The example systems and devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability, and, hence, are considered machine-implemented. Generally, any of the functions described with reference to the figures can be implemented using software, hardware (e.g., fixed logic circuitry) or a combination of these implementations. The terms “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions), such as the program code for the SPS module 102, that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations or embodiments, as described and as illustrated in the drawings. However, this disclosure is not limited to the implementations described and illustrated herein, but can extend to other implementations, as would be known or as would become known to those skilled in the art. Reference in the specification to “one embodiment,” “particular embodiments,” “this implementation,” “some embodiments”, or other terms of similar import, means that a particular feature, structure, or characteristic described is included in at least one implementation or embodiment, and the appearances of these phrases in various places in the specification are not necessarily all referring to the same implementation/embodiment.

Although the present disclosure has been described in connection with several embodiments, the disclosure is not intended to be limited to the specific forms set forth herein. On the contrary, it is intended to cover such alternatives, modifications, and equivalents as can be reasonably included within the scope of the disclosure as defined by the appended claims.

What is claimed is:

1. A method comprising:
receiving, by a computing system, a Material Requisition Plan (MRP) identifying a product to be procured by a manufacturer;
selecting, by the computing system, a list of suppliers of the product based on the MRP; and
using, by the computing system, a machine learning (ML) module to identify a pre-defined number of top-ranked suppliers from the list of suppliers based on evaluation of each supplier in the list against a plurality of business features.

2. The method of claim 1, wherein the pre-defined number is specified by a user.

3. The method of claim 1, wherein the plurality of business features includes:
a supply efficiency feature indicating how efficiently a supplier can supply the product;
a change flexibility feature indicating how flexible a supplier is as to quantity, quality, and delivery of the product;
a supplier strength feature indicating financial and innovation strength of a supplier;
a cost feature indicating overall cost competitiveness of a supplier;
a time feature indicating an average time a supplier takes to deliver the product; and
a risk feature indicating an overall product delivery risk associated with a supplier.

4. The method of claim 1, further comprising:
further receiving, by the computing system, a list of preferred suppliers of the product, wherein the list of preferred suppliers is a subset of the list of suppliers of the product, and
wherein the pre-defined number indicates a maximum number of suppliers that can be identified by the ML module from the list of preferred suppliers.

5. The method of claim 1, wherein selecting the list of suppliers comprises:
grouping, by the computing system, a plurality of suppliers associated with the manufacturer into a plurality of product-specific groups, wherein each group contains a roster of one or more suppliers from the plurality of suppliers that are qualified to supply a corresponding product to the manufacturer;
storing, by the computing system, the plurality of product-specific groups in a database;
identifying, by the computing system, the product specified in the MRP; and
accessing, by the computing system, the database to select one of the plurality of product-specific groups corresponding to the product specified in the MRP as the list of suppliers.

6. The method of claim 1, wherein using the ML module comprises:
evaluating, by the computing system, each supplier in the list against the plurality of business features using the ML module to generate a plurality of feature-specific scores for each supplier in the list;
for each supplier in the list, combining, by the computing system, all feature-specific scores of the supplier to generate a supplier-specific final score; and
ranking, by the computing system, each supplier in the list based on the supplier-specific final score.

7. The method of claim 6, further comprising:
using the ML module, by the computing system, to assign a supplier-specific Total Available Material (TAM) percentage for the MRP to each of the pre-defined number of top-ranked suppliers in the list.

8. The method of claim 6, further comprising:
using, by the computing system, the ML module to analyze each feature-specific score for each supplier in the list;
further using, by the computing system, the ML module to provide a plurality of feature-specific predictions for each supplier in the list based on the analysis of each feature-specific score for the corresponding supplier; and
further using, by the computing system, the ML module to assign a supplier-specific Total Available Material (TAM) percentage for the MRP to at least one supplier in the list based on the plurality of feature-specific predictions for the at least one supplier.

9. The method of claim 1, further comprising:
receiving, by the computing system, historical data containing a plurality of order-specific performance datasets, wherein each dataset in the plurality of performance datasets provides information about a corresponding past product order of the manufacturer, a portfolio of suppliers associated with the product order, and a profit associated with the product order; and
training, by the computing system, the ML module with the historical data to generate a trained version of the ML module;
wherein using the ML module includes:
using the trained version of the ML module to identify the pre-defined number of top-ranked suppliers.

10. A computing system comprising:
a memory storing program instructions; and
a processing unit coupled to the memory and operable to execute the program instructions, which, when executed by the processing unit, cause the computing system to:
receive a Material Requisition Plan (MRP) identifying a product to be procured by a manufacturer;
select a list of suppliers of the product based on the MRP; and
use a machine learning (ML) module to identify a pre-defined number of top-ranked suppliers from the list of suppliers based on evaluation of each supplier in the list against a plurality of business features.

11. The computing system of claim 10, wherein the program instructions, upon execution by the processing unit, cause the computing system to:
further receive a list of preferred suppliers of the product, wherein the list of preferred suppliers is a subset of the list of suppliers of the product, and wherein the pre-defined number indicates a maximum number of suppliers that can be identified by the ML module from the list of preferred suppliers.

12. The computing system of claim 10, wherein the program instructions, upon execution by the processing unit, cause the computing system to:
group a plurality of suppliers associated with the manufacturer into a plurality of product-specific groups, wherein each group contains a roster of one or more suppliers from the plurality of suppliers that are qualified to supply a corresponding product to the manufacturer;
store the plurality of product-specific groups in a database;
identify the product specified in the MRP; and
access the database to select one of the plurality of product-specific groups corresponding to the product specified in the MRP as the list of suppliers.

13. The computing system of claim 10, wherein the program instructions, upon execution by the processing unit, cause the computing system to:
evaluate each supplier in the list against the plurality of business features using the ML module to generate a plurality of feature-specific scores for each supplier in the list;
for each supplier in the list, combine all feature-specific scores of the supplier to generate a supplier-specific final score; and
rank each supplier in the list based on the supplier-specific final score.

14. The computing system of claim 13, wherein the program instructions, upon execution by the processing unit, cause the computing system to:
use the ML module to assign a supplier-specific Total Available Material (TAM) percentage for the MRP to each of the pre-defined number of top-ranked suppliers in the list.

15. The computing system of claim 10, wherein the program instructions, upon execution by the processing unit, cause the computing system to:
receive historical data containing a plurality of order-specific performance datasets, wherein each dataset in the plurality of performance datasets provides information about a corresponding past product order of the manufacturer, a portfolio of suppliers associated with the product order, and a profit associated with the product order;
train the ML module with the historical data to generate a trained version of the ML module; and
use the trained version of the ML module to identify the pre-defined number of top-ranked suppliers.

16. The computing system of claim 10, wherein the plurality of business features includes:
a supply efficiency feature indicating how efficiently a supplier can supply the product;
a change flexibility feature indicating how flexible a supplier is as to quantity, quality, and delivery of the product;
a supplier strength feature indicating financial and innovation strength of a supplier;
a cost feature indicating overall cost competitiveness of a supplier;
a time feature indicating an average time a supplier takes to deliver the product; and
a risk feature indicating an overall product delivery risk associated with a supplier.

17. A computer program product comprising a non-transitory computer-usable medium having computer-readable program code embodied therein, the computer-readable program code adapted to be executed by a computing system to implement a method comprising:
receiving a Material Requisition Plan (MRP) identifying a product to be procured by a manufacturer;
selecting a list of suppliers of the product based on the MRP; and
using a machine learning (ML) module to identify a pre-defined number of top-ranked suppliers from the list of suppliers based on evaluation of each supplier in the list against a plurality of business features.

18. The computer program product of claim 17, wherein the method further comprises:
further receiving a list of preferred suppliers of the product, wherein the list of preferred suppliers is a subset of the list of suppliers of the product, and wherein the pre-defined number indicates a maximum number of suppliers that can be identified by the ML module from the list of preferred suppliers.

19. The computer program product of claim 17, wherein the method further comprises:
evaluating each supplier in the list against the plurality of business features using the ML module to generate a plurality of feature-specific scores for each supplier in the list;
for each supplier in the list, combining all feature-specific scores of the supplier to generate a supplier-specific final score;
ranking each supplier in the list based on the supplier-specific final score; and
using the ML module to assign a supplier-specific Total Available Material (TAM) percentage for the MRP to each of the pre-defined number of top-ranked suppliers in the list.

20. The computer program product of claim 17, wherein the method further comprises:
receiving historical data containing a plurality of order-specific performance datasets, wherein each dataset in the plurality of performance datasets provides information about a corresponding past product order of the manufacturer, a portfolio of suppliers associated with the product order, and a profit associated with the product order;
training the ML module with the historical data to generate a trained version of the ML module; and
using the trained version of the ML module to identify the pre-defined number of top-ranked suppliers.
